(19) United States
(12) Patent Application Publication
(10) Pub. No.: US 2013/0140258 A1
(43) Pub. Date: Jun. 6, 2013

(54) BALLAST WAGON FOR A DERRICK CRANE

(71) Applicant: Liebherr-Werk Ehingen GmbH, Ehingen/Donau (DE)

(72) Inventor: Uwe Frommelt, Ehingen/Donau (DE)

(73) Assignee: LIEBHERR-WERK EHINGEN GMBH, Ehingen/Donau (DE)

(21) Appl. No.: 13/689,387

(22) Filed: Nov. 29, 2012

(30) Foreign Application Priority Data
Dec. 1, 2011 (DE) 10 2011 119 947.4
Jan. 24, 2012 (DE) 10 2012 001 377.9

(51) Int. Cl. B66C 23/76

(52) U.S. Cl. CPC B66C 23/76
USPC 212/196

(57) ABSTRACT

The present disclosure relates to a ballast wagon for a derrick crane. The ballast wagon has two wheeled portions which each have at least two wheelsets with a respective one wheel. The two wheeled portions are arranged rotatably at a frame of the ballast wagon. The at least two wheelsets of a wheeled portion are formed pivotable independently of one another about a respective pivot axis.

### CROSS REFERENCE TO RELATED APPLICATIONS

This application claims priority to German Patent Application No. 10 2011 119 947.4, entitled “Ballast Wagon for a Derrick Crane,” filed Dec. 1, 2011, and German Patent Application No. 10 2012 001 377.9, entitled “Ballast Wagon for a Derrick Crane,” filed Jan. 24, 2012, both of which are hereby incorporated by reference in their entirety for all purposes.

### TECHNICAL FIELD

The present disclosure relates to a ballast wagon for a derrick crane.

### BACKGROUND AND SUMMARY

It is known in large derrick cranes to use a ballast wagon arrangement which comprises a plurality of ballast wagons. A respective specific quantity of ballast plates is arranged on the individual ballast wagons, which has the advantage that when the crane rotates, the ballast plates can be co-rotated without it being necessary to raise them from the ground. The ballast wagon arrangement is in this respect connected to the superstructure of the derrick crane by a ballast wagon guide.

Known ballast wagons usually have a carrier frame on which the ballast plates can be arranged as well as an undercarriage which allows a moving of the ballast wagon on a rotation of the crane.

In particular when a ballast wagon arrangement is used which has a plurality of individual ballast wagons, they cover a large area on the ground. There is the risk in the uneven region of use of ballast wagons that the uneven areas can result in strains in the ballast wagon or in the ballast wagon arrangement. The strains can in turn result in damage to the ballast wagon.

It is therefore the object of the present disclosure to provide a ballast wagon in which at least one of the above-named disadvantages does not occur.

The object is satisfied by a ballast wagon for a derrick crane comprising a frame and at least two wheeled portions. The wheeled portions are arranged rotatable at the frame and each have at least two wheelsets each having at least one wheel. The at least two wheelsets of a wheeled portion are formed pivotable independently of one another about a respective pivot axis. The ballast wagon can be used with a derrick crane.

The advantage of a provision of at least two wheelsets which are pivotable about a respective pivot axis independently of one another is that a degree of freedom is provided for compensating ground irregularities. It can be achieved by such a design of the at least two wheelsets that no wheel of a wheeled portion raises from the ground on an irregularity. It can particular be achieved when a plurality of ballast wagons are used in a ballast wagon arrangement that no wheel of a ballast wagon raises from the ground. It can additionally be achieved that no strains arise in the ballast wagon and/or in the ballast wagon arrangement in the event of irregularities.

In an example embodiment, a linkage can be provided which is formed rotatable to the frame. Alternatively or additionally, the linkage can be connected to the frame, in particular to a rotating assembly of the frame. In this respect, the linkage can be made releasable with the frame and/or the rotating assembly. An axis of rotation of the rotating assembly substantially extends perpendicular to the ground and/or substantially perpendicular to a plane of the frame facing the ground. The direction in which the ballast wagon should move can be controlled by a rotation of the rotating assembly. The linkage can be coupled to both wheelsets of a wheeled portion, with an axis of rotation of the linkage being able to be formed in parallel to a pivot axis of the at least two wheelsets. The axis of rotation of the linkage and/or the respective pivot axis of the wheelsets can lie substantially in parallel to the plane of the frame facing the ground. Ground irregularities can be compensated and strains kept away from the ballast wagon by the linkage.

The linkage can be coupled, in particular directly, at one end to a first suspension of a first wheelset and at another, opposite, end to a second suspension of a second wheelset. The coupling of the linkage to the first and/or second suspension can take place directly via a pin connection, for example. The use of a pin provides the advantage that a secure coupling can be achieved in a simple manner between the linkage and the suspensions. The axis of rotation of the linkage can lie between the two ends of the linkage which are coupled to the corresponding suspension.

Each of the two suspensions is coupled, in particular directly to a rotary shaft of the at least one wheel of the first or second wheelsets. It is thereby achieved that the force acting on the wheel and thus on the rotary shaft of the wheel in the event of ground irregularities is transmitted to the respective suspension.

A rotary movement of the linkage can be bounded by abutments. The abutments can be arranged at the frame, in particular at the rotating assembly connected to the frame, and/or at the linkage.

In an example embodiment, the ballast wagon can have a drive unit for driving the wheeled portions. In this respect, the drive unit can be designed so that it drives one or more wheeled portions and/or one or more wheelsets of a wheeled portion and/or one or more wheels of a wheelset. A drive of a slewing gear for moving the superstructure relative to the undercarriage can be dispensed with at the crane due to the drive unit. This is possible since the ballast wagon which can be coupled to the superstructure is used as the drive of the slewing gear. The corresponding connection, in particular a ballast wagon guide, between the crane and the ballast wagon must naturally then be made strong enough to transmit the forces from the ballast wagon to the superstructure of the crane.

The frame of the ballast wagon can be coupled, in particular directly, to a carrier frame. Ballast elements can be stacked on the carrier frame. The carrier frame can in turn be coupled, in particular directly, to a connection frame. The connection frame can be coupled to a superstructure of a derrick crane and/or to a derrick boom and/or to a further ballast wagon.

In this respect, the carrier frame can be provided above the frame in a direction away from the wheels and the connection frame can be provided above the carrier frame. As a result, a simply designed ballast wagon can be provided which is of a modular structure. The coupling of the frame to the carrier frame and/or of the carrier frame to the connection frame can be made in an articulated manner.

The frame of the ballast wagon can be made releasable from the carrier frame and the carrier frame can be made releasable from the connection frame. The carrier frames can advantageously be connected to the connection frame and/or to a carrier frame of another ballast wagon by intermediate frames. The provision of intermediate frames makes it possible to enlarge the contact surface for the ballast elements. It is naturally possible that the carrier frames of the ballast wagons are connected directly to one another.

At least one pin connection can be used for connecting the carrier frames to the intermediate frame and/or to a carrier frame of another ballast wagon. The pin connection makes a rotation of the carrier frame possible in a first direction and cooperates with an abutment arrangement which prevents a pivoting in the opposite direction. The pin connection in particular allows an upward pivoting—that is in a direction away from the wheels—while a downward pivoting—that is in a direction toward the wheels—is prevented by the abutment arrangement.

The carrier frame can for this purpose have pin connection points in an upper region, while it has abutment elements in a lower region. The abutment elements can be provided, for example, as mechanically machined surfaces. The additional degree of freedom due to the pin connection prevents unnecessary stains between a plurality of ballast wagons. Furthermore the carrier frame can be manufactured as modular due to its previously named structure. The carrier frame can naturally also be designed so that a further pin connection is provided instead of the abutment arrangement. However, a movement option is lost in this case.

In this respect, at least two ballast wagon, in particular connected to one another, can form a ballast wagon arrangement. The carrier frame can in particular be formed so that it couples four ballast wagons to one another. The connection frame can be connected to at least two carrier frames which are each coupled to four ballast wagons. The ballast wagon arrangement can naturally also have fewer or more than eight ballast wagons. Due to the modular design of the ballast wagon arrangement, it still remains transportable on the road and nevertheless allows higher ballast weights.

The ballast wagons or the ballast wagon arrangement can be used in a derrick crane. The derrick crane can have an undercarriage, a superstructure rotatable relative to the undercarriage, a main boom and a derrick boom. The superstructure can be connected to a ballast wagon or to a ballast wagon arrangement by the ballast wagon guide.

The use of the ballast wagon or of the ballast wagon arrangement is naturally not limited to derrick cranes. The ballast wagon or the ballast wagon arrangement can be used in any crane in which at least one part of the ballast elements is not arranged at the crane itself, but rather at at least one ballast wagon.

Further details and advantages of the present disclosure will now be explained in more detail with reference to an embodiment shown in the drawing.

### BRIEF DESCRIPTION OF THE FIGURES

FIG. 1 shows a rear view of a ballast wagon in accordance with the present disclosure.

FIG. 2 shows a side view of the ballast wagon in accordance with the present disclosure.

FIG. 3 shows a rear view of a plurality of ballast wagons in accordance with the present disclosure which are connected to one another by a carrier frame.

FIG. 4 shows a representation of a plurality of ballast wagons in accordance with the present disclosure which are coupled to one another by a connection frame.

FIG. 5 shows a rear view of a plurality of ballast wagons in accordance with the present disclosure at which ballast elements are arranged.

FIG. 6 shows a side view of a plurality of ballast wagons in accordance with the present disclosure at which ballast elements are arranged.

FIG. 7 shows a side view of a crane and of a ballast wagon arrangement.

### DETAILED DESCRIPTION

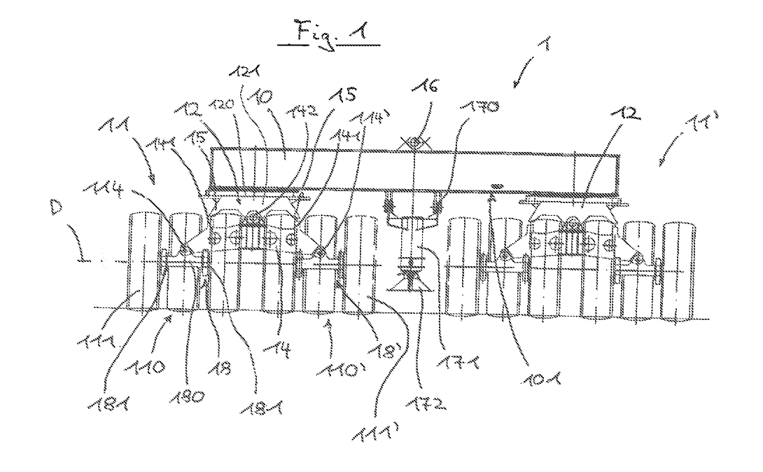

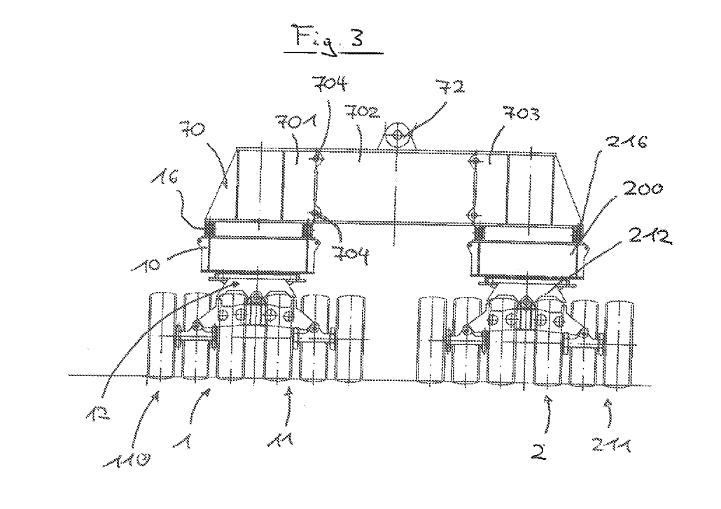

The ballast wagon 1 shown in FIG. 1 has a frame 10 and two wheeled portions 11, 11′. The frame 10 is connected to a cylinder 171 via a support frame 170. The cylinder 171 has a connection to a support plate 172, with the connection being made in a known manner and allowing a pivot movement. The cylinder 171 is retracted during the crane work and the support plate 172 is raised from a ground. In addition, the frame 10 has a coupling point 16 at which the frame 10 can be releasably coupled to a carrier frame 70 shown in FIG. 3. The support plate 172 is pressed against the ground to simplify a rotation of the wheeled portions 11, 11′, in particular of the wheels 111, 111′ of the wheeled portions. The frame 10 is furthermore coupled to the respective wheeled portion 11, 11′ by a rotating assembly 12 and a linkage 14 respectively.

Each of the two wheeled portions 11, 11′ has a first wheelset 110 and a second wheelset 110′. The first and also the second wheelset 110, 110′ each have three wheels 111, 111′. Both the wheeled portions 11, 11′ and the connections thereof at the frame 10 via the linkage 14 and the rotating assembly 12 are of the same configuration so that in the following the design of only one single wheeled portion 11 and its connection to the frame 10 will be looked at.

The rotating assembly 12 can have a rotary portion 120 and an intermediate piece 121 which is connected to the rotary portion 120. The rotary portion 120 can rotate about an axis of rotation which is substantially perpendicular to the ground and/or parallel to a plane 101 of the frame 10 facing toward the ground. The rotating assembly 12 is additionally coupled to a linkage 14. The intermediate piece 121 is directly coupled to the linkage 14, with the coupling being formed such that the linkage 14 can rotate relative to the rotating assembly 12. In this respect, an axis of rotation 142 of the linkage 14 is substantially perpendicular to the axis of rotation of the rotating assembly 12. The axis of rotation 142 of the linkage 14 in particular extends substantially parallel to the plane 101 of the frame 10.

The linkage 14 has two abutments 141, with the rotary axle 142 of the linkage 14 being arranged between the two abutments 141. On a rotation of the linkage 14, one of the two abutments 141 abuts a counter-abutment 15 arranged at the rotating assembly 12. A rotary movement of the linkage 14 is therefore limited by the abutments 15, 141.

The linkage 14 is furthermore directly coupled to a first suspension 18 at one end and to a second suspension 18′ at another end. The rotary axle 142 of the linkage 14 is arranged between the two ends of the linkage 14 which are coupled to the wheel suspensions 18, 18′. In this respect, the spacing between an end of the linkage 14 and the rotary axle 142 is greater than the spacing between an abutment 141 and the rotary axle 142.

The first and second wheelsets 110, 110′ are formed pivotable with respect to the linkage 14 via the respective wheel suspension 18, 18′. The first wheelset 110 is thus formed pivotable with respect to a first pivot axis 114 via the first wheel suspension 18. The second wheelset 110′ can be pivoted with respect to a second pivot axis 114′ via the second wheel suspension 18′. The first and second pivot axes 114, 114′ are formed substantially parallel to the axis of rotation 142 of the linkage 14. In addition, the first wheelset 110 can be pivoted about the linkage 14 independently of the second wheelset 110′. This is possible since the first and second wheelsets 110, 110′ have mutually separate rotary shafts. More precisely, the wheels 111 of the first wheelset 110 are connected to a first rotary shaft and the wheels 111′ of the second wheelset 111′ are connected to a second rotary shaft separate from the first rotary shaft.

Both suspensions 18, 18′ are of the same design so that in the following only the design of a single suspension 18 will be explained. The suspension 18 has a short section 180 which extends substantially in parallel to a middle axis D of the respective rotary shaft of the wheels 111. The short section 180 is directly coupled to the linkage 14 and is connected in each case at its two ends to a longitudinal section 181.

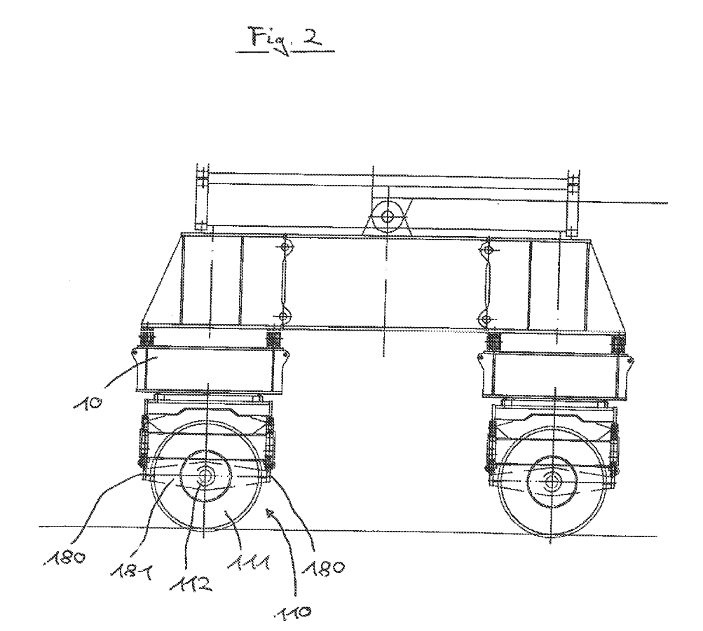

As can be seen from FIG. 2, the longitudinal section 181 extends diametrically to the wheel 111 between two short sections 180 which are oppositely disposed relative to a middle axis D of the rotary shaft 112. Starting from the respective short section 180, the longitudinal section 181 has a cross-section enlarging in the direction toward the rotary shaft 112 and surrounds the rotary shaft 112 of the wheel 111. The longitudinal section 181 has the greatest cross-section in the region of the rotary shaft 112 of the wheel 111. The wheelset 110 shown in FIG. 2 can be rotated about 90° by the rotating assembly 12 and the position shown in FIG. 3 can thus be obtained. The wheelset 110 can naturally be rotated by an angle other than 90° by the rotating assembly.

In FIG. 3, a ballast wagon arrangement having two ballast wagons 1, 2 is shown from a side view. In this respect, only one wheeled portion 11, 211 is shown of each ballast wagon 1, 2, with both ballast wagons naturally having at least one further wheeled portion not visible in FIG. 3. The wheeled portion 11, 211 is, as already discussed, connected to the frame 10, 200 via the respective rotating assembly 12, 212. The frame 10, 200 is connected to a carrier frame 70 via a pin connection, for example, at the coupling point 16, 216. In this respect, both ballast wagons 1, 2 are connected to the same carrier frame 70. The carrier frame 70 can have a plurality of sections 701, 702, 703 which are mutually connected. The individual sections 701, 702, 703 can in particular be rigidly connected to one another via two pin connections 704.

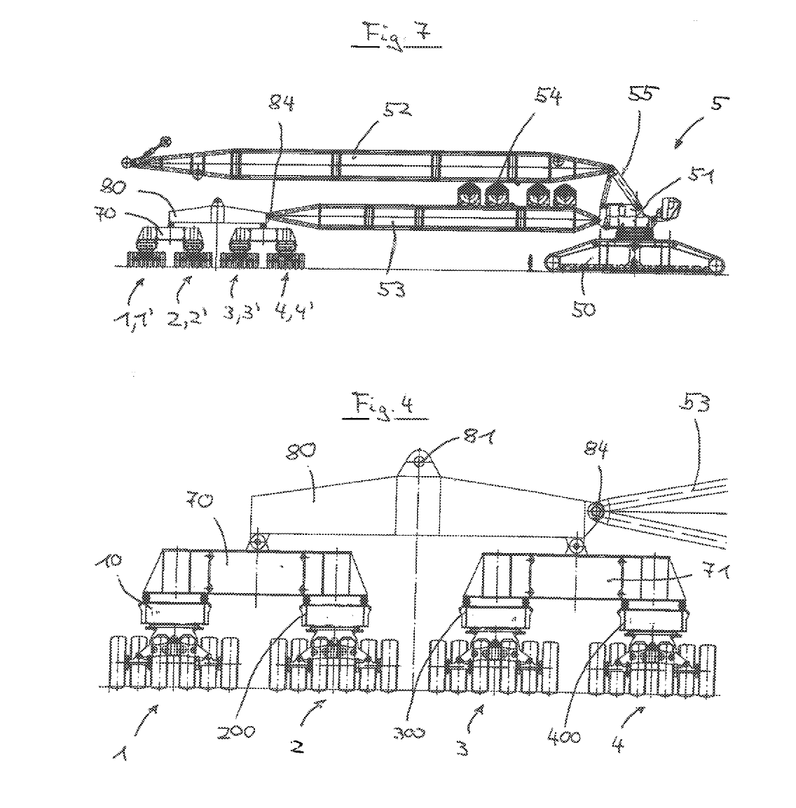

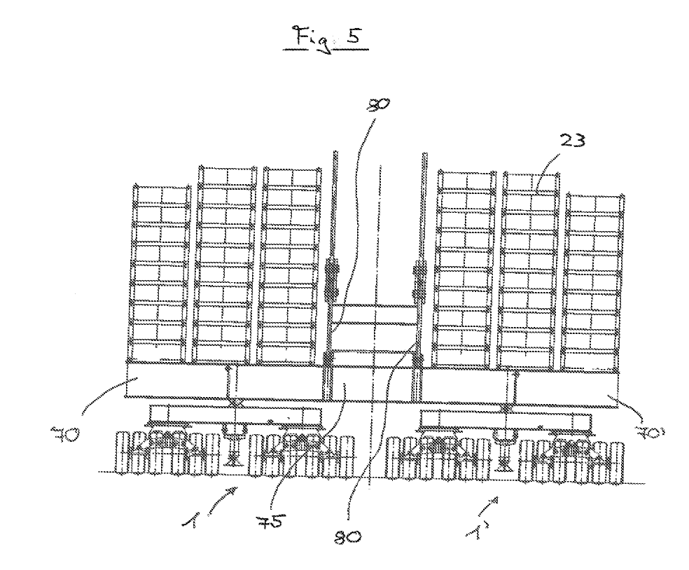

The carrier frame 70 serves the reception of ballast elements 23 shown in FIG. 5 and can be directly connected to a connection frame 80 shown in FIG. 4 at a fastening point 72.

A ballast wagon arrangement having four ballast wagons 1, 2, 3, 4 is shown in FIG. 4. The ballast wagons 1, 2, 3, 4 are of the same design as the ballast wagon 1 shown in FIG. 1 and are connected to a frame 10, 200, 300, 400 in an analog manner thereto by a rotating assembly. In this respect, the two frames 10, 200 of the two ballast wagons 1, 2 are connected, in particular directly, to a first carrier frame 70 and the two frames 300, 400 are connected, in particular directly, to a second carrier frame 71. The two carrier frames 70, 71 are both pivotally connected to the same connection frame 80. The connection can be ensured via a pin, for example.

The connection frame 80 has a pivot point 84 by means of which the connection frame 80 is connected to the crane 5 shown in FIG. 7. Furthermore, a fastening point 81 is provided at the connection frame 80. The connection frame 80 is connected to a derrick boom 52 shown in FIG. 5 via the fastening point 81 and a guying arrangement.

Analog to FIG. 3, only one wheeled portion of each ballast wagon 1, 2, 3, 4 is shown in FIG. 4. The respective ballast wagon 1, 2, 3, 4 naturally has at least one further wheeled portion.

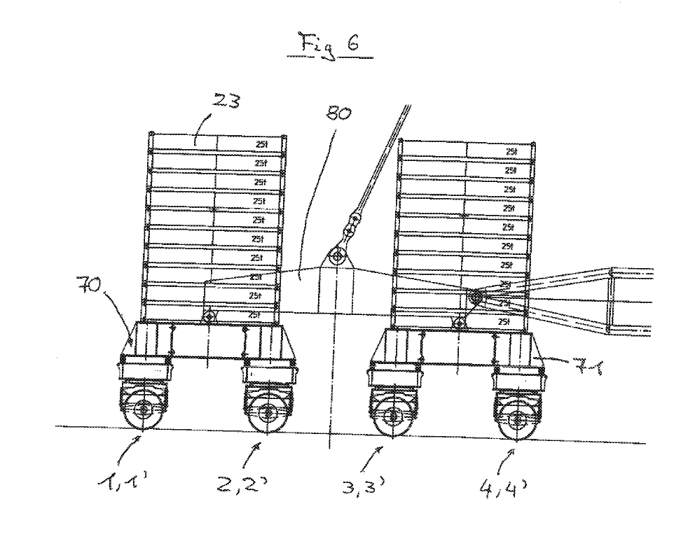

FIGS. 5 and 6 show a ballast wagon arrangement which is composed of a total of eight ballast wagons. In this respect, FIG. 5 shows a rear view and FIG. 6 a side view of the ballast wagon arrangement. A plurality of ballast elements 23 are arranged on the carrier frames 70, 70″, in particular on ballast-receiving surfaces of the carrier frames 70, 70′ of the individual ballast wagons.

As can be seen from FIG. 5, the carrier frames 70, 70′ are respectively connected to the connection frame 80 by two adjacent ballast wagons 1, 1′. In addition, the two carrier frames 70, 70′ are connected to one another via an intermediate frame 75, which is arranged between the two carrier frames 70, 70′. The carrier frames 70, 70′ are, as can be seen in FIG. 6, further designed so that they connect the ballast wagon 1, 1′ to another ballast wagon 2, 2′ in a direction parallel to the longitudinal extent of the connection frame 80. In this respect, the four ballast wagons 1, 1′, 2, 2′ form a first ballast wagon unit. The connection frame 80 connects the first ballast wagon unit to a second ballast wagon unit. The second ballast wagon unit is likewise composed of four ballast wagons 3, 3′, 4, 4′ and is equally of the same design as the first ballast wagon unit.

FIG. 7 shows a side view of a crane 5 and of a ballast wagon arrangement which is composed of a plurality of ballast wagons 1, 1′, 2, 2′, 3, 3′, 4, 4′. In this respect, the ballast wagon arrangement can, analog to the ballast wagon arrangement shown in FIGS. 5 and 6, have eight ballast wagons.

The crane 5 has an undercarriage 50 and a superstructure 51 rotatable relative to the undercarriage 50. The superstructure 50 is connected to the connection frame 80 of the ballast wagon arrangement by a ballast wagon guide 53. The ballast wagon guide 53 is in particular connected directly to the superstructure 50 and directly to the pivot point 84 of the connection frame 80. Winches 54 are attached to the ballast wagon guide 53.

The crane 5 furthermore has a derrick boom 52 which is directly connected to a spacer 55 at one end. The spacer 55 is directly connected to the superstructure 50 at its end remote from the derrick boom 52. The derrick boom 52 is coupled at its end remote from the space 55 via a guying arrangement, not shown, to the connection frame 80, in particular to the fastening point 81 of the connection frame 80.

The operation of the ballast wagon will be explained in the following. Even though the explanation takes place with the aid of reference numerals, the present disclosure is not restricted to the embodiments shown in the Figures.

The direction of the individual ballast wagons can be controlled by the rotating assembly 12. The rotating assembly 12 can thus be rotated accordingly for a change of direction of the ballast wagon. The rotary movement of the rotating assembly 12 is transferred by the linkage 14 to the wheel suspensions 18, 18′ and thus to the corresponding rotary shaft of the wheels 111, 111′ of the first and second wheelsets 110, 110′. In this respect, as known from the prior art, each wheelset 110, 110′ can be set by a crane control to a desired steering program or steering center.

In the event that only one of the two wheelsets 110, 110′ of a wheeled portion 11, 11′ lies on a ground irregularity, a force acts on the wheelset 110, 110′ lying on the ground irregularity as a result of the ground irregularity. This force has the effect that the corresponding wheelset 110, 110′ pivots about the respective pivot axis 114, 114′. The wheelset 110, 110′ not lying on the ground irregularity is not pivoted.

1. A ballast wagon for a derrick crane comprising:
a frame and at least two wheeled portions which each have at least two wheelsets each having at least one wheel, wherein the at least two wheeled portions are arranged rotatably at the frame and the at least two wheelsets of a wheeled portion are pivotable independently of one another about a respective pivot axis.

2. A ballast wagon in accordance with claim 1, further comprising a linkage which is formed rotatably toward the frame and/or is connected to the frame.

3. A ballast wagon in accordance with claim 2, wherein the linkage is coupled to a first suspension of a first wheelset at one end and to a second suspension of a second wheelset at another end.

4. A ballast wagon in accordance with claim 3, wherein the linkage is coupled to the first and second suspensions by a respective pin connection.

5. A ballast wagon in accordance with claim 2, wherein the rotary movement of the linkage is limited by abutments.

6. A ballast wagon in accordance with claim 1, further comprising a drive unit for driving at least one wheel.

7. A ballast wagon in accordance with claim 1, wherein the frame is connected to a carrier frame for carrying ballast elements.

8. A ballast wagon in accordance with claim 7, wherein the carrier frame is coupled to a connection frame which is couplable to a superstructure of the derrick crane and/or to a derrick boom of the derrick crane and/or to further ballast wagons.

9. The ballast wagon of claim 2, wherein the linkage is connected to a rotating assembly of the frame.

10. A ballast wagon arrangement, comprising:
a first ballast wagon including a first frame and at least two first wheeled portions which each have at least two first wheelsets, each having at least one wheel, wherein the at least two first wheeled portions are arranged rotatably at the first frame and the at least two first wheelsets of at least one of the first wheeled portions are pivotable independently of one another about a respective first pivot axis; and
a second ballast wagon including a second frame and at least two second wheeled portions which each have at least two second wheelsets, each having at least one wheel, wherein the at least two second wheeled portions are arranged rotatably at the second frame and the at least two second wheelsets of at least one of the second wheeled portions are pivotable independently of one another about a respective second pivot axis, wherein the first and second ballast wagons are mutually connected.

11. A ballast wagon arrangement in accordance with claim 11, wherein the first ballast wagon further comprises a first linkage which is formed rotatably toward the first frame, and wherein the second ballast wagon further comprises a second linkage which is formed rotatably toward the second frame.

12. A derrick crane comprising:
an undercarriage;
a superstructure rotatable relative to the undercarriage;
a main boom;
a derrick boom; and
a ballast wagon for a derrick crane including a frame and at least two wheeled portions which each have at least two wheelsets each having at least one wheel, wherein the at least two wheeled portions are arranged rotatably at the frame and the at least two wheelsets of at least one of the wheeled portions are pivotable independently of one another about a respective pivot axis, the ballast wagon connected to the superstructure by a ballast wagon guide.

13. A derrick crane in accordance with claim 12, wherein the ballast wagon further comprises a linkage which is formed rotatably toward the frame and/or is connected to the frame.

14. A derrick crane in accordance with claim 13, wherein the linkage is coupled to a first suspension of a first wheelset at one end and to a second suspension of a second wheelset at another end.

15. A derrick crane in accordance with claim 14, wherein the linkage is coupled to the first and second suspensions by a respective pin connection.

16. A derrick crane in accordance with claim 13, wherein the rotary movement of the linkage is limited by abutments.

17. A derrick crane in accordance with claim 12, wherein the ballast wagon further comprises a drive unit for driving at least one wheel separate from drive units of the crane.

18. A derrick crane in accordance with claim 12, wherein the frame is connected to a carrier frame for carrying ballast elements.

19. A derrick crane in accordance with claim 18, wherein the carrier frame is coupled to a connection frame which is coupled to the superstructure of the derrick crane.

20. A derrick crane in accordance with claim 18, wherein the carrier frame is coupled to a connection frame which is coupled to the main boom.
